(19) United States
(12) Patent Application Publication
(10) Pub. No.: US 2004/0130453 A1
(43) Pub. Date: Jul. 8, 2004

(54) Traffic controller emergency power supply

(76) Inventor: William H. Zinn, Cave Creek, AZ (US)

Correspondence Address: G. F. Gallinger, 7420 Milner Dr., #1000, Colorado Springs, CO, 80920, US

(21) Appl. No.: 10/335,410

(22) Filed: Jan. 3, 2003

(51) Int. Cl. G08B 21/00

(52) U.S. Cl. 340/636.1

(57) ABSTRACT

A low maintenance emergency power supply which operates for a sufficient period to send an alarm to a remote location in the event of a power failure. The emergency power supply has particular application with traffic signal controllers. In the event of a primary power failure a traffic signal controller has insufficient time to transmit a signal to a central monitoring location that a power outage has occurred. Personnel monitoring the traffic controller from the central location do not know if the controller has lost power or if the communications line between the controller and central monitoring location has been lost. The emergency power supply comprises: a capacitor to store power, and, a voltage regulator connected serially to the capacitor output to maintain a constant output. In the event of a primary power failure a constant voltage is maintained for a sufficient period to transmit an alarm signal. In one aspect of the invention the emergency power supply is devised to receive an output from an existing power supply and plug into the power input of an existing traffic signal controller.

### FIELD OF THE INVENTION

This invention relates to intersection traffic controllers and traffic signals. More particularly this invention relates to a low maintenance emergency power supply which operates for a sufficient period to allow the traffic controller to send an alarm to a central location in the event of a power failure. The emergency power supply operates without the need for a battery back up or other auxiliary power supply.

### BACKGROUND OF THE INVENTION

If power supply for intersection signals and a traffic controller is lost then the traffic in all directions is required to treat the intersection as if it had stop signs. This is hazardous to the safety of the motorists especially at low volume intersections. At high volume intersections there is substantial confusion and delay to motorists. Motorists travelling in all directions usually stop and proceed only when it seems safe to do so. Usually traffic backs up, especially along the most heavily travelled roadway, while motorists alternate, a single car at a time, proceeding through the intersection.

In the event of a power loss a typical traffic controller power supply will supply 30 watts for 550 ms. This time is insufficient to transmit an alarm signifying that a power outage has occurred. Personnel monitoring the traffic controller from a central location do not know if the controller has lost power or if the communications line between the controller and central monitoring location has been lost.

It is necessary that maintenance personnel be immediately dispatched when power supply to a traffic control light is lost. The problem with existing practice is that in order to generate a power loss alarm signal an auxiliary power supply must be maintained. The odds are substantial that one of many traffic control lights will regularly have its power supply interrupted due to weather, a collision, or excavation. However, it is probable that any particular traffic control light will operate for years without a power supply intervention. Battery back up power supplies are a high maintenance item which are unreliable and prohibitively expensive to maintain. What is needed is a power loss signal generator which does not require an auxiliary power supply.

### OBJECTS OF THE INVENTION

It is an object of this invention minimize downtime of traffic control lights in the event of a power loss, and thereby improve safety at traffic intersections. It is an object of this invention to more quickly restore normal traffic flow through an intersection subsequent to an interruption of power to a traffic control light. It is an object of this invention to disclose a power loss signal generator which does not require an auxiliary power supply and which accordingly, is more reliable and substantially more economical than a power loss signal generator powered by an auxiliary battery powered supply. It is yet a further object of this invention to disclose an economical apparatus to signal personnel at a central monitoring location that a particular traffic controller has lost power. Personnel then need not first investigate a communication loss before dispatching utility repair men. It is a final object of this invention to disclose a vehicular traffic controller power supply which reliably stores sufficient power in the event of a power loss to keep the traffic controller active for a sufficient period to have an alarm message sent to the monitoring center.

One aspect of this invention provides for an emergency power supply comprising: a capacitor to store power, and a voltage regulator connected serially to the capacitor output to maintain a constant output. A relay may be used to immediately generate an alarm signal in the event of a primary power supply failure. In the event of a primary power failure a constant voltage is maintained for a sufficient period to transmit an alarm signal.

In a preferred aspect of the invention the emergency power supply is devised to receive an output from an existing power supply and plug into the power input of an existing traffic signal controller. In yet another aspect of this invention the emergency power supply is embedded in a power supply for a traffic signal controller.

Various other objects, advantages and features of this invention will become apparent to those skilled in the art from the following description in conjunction with the accompanying drawings.

### FIGURES OF THE INVENTION

FIG. 1 is a schematic drawing of an emergency power supply embedded within a power supply for a traffic signal controller requiring a direct current power supply.

FIG. 2 is a schematic drawing of an emergency power supply configured to be serially connected between a conventional direct current power supply for a traffic signal controller and the traffic signal controller.

FIG. 3 is a schematic drawing of an emergency power supply embedded within a power supply for a traffic signal controller requiring an alternating current power supply.

FIG. 4 is a schematic drawing of an emergency power supply configured to be serially connected between a conventional alternating current power supply for a traffic signal controller and the traffic signal controller.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

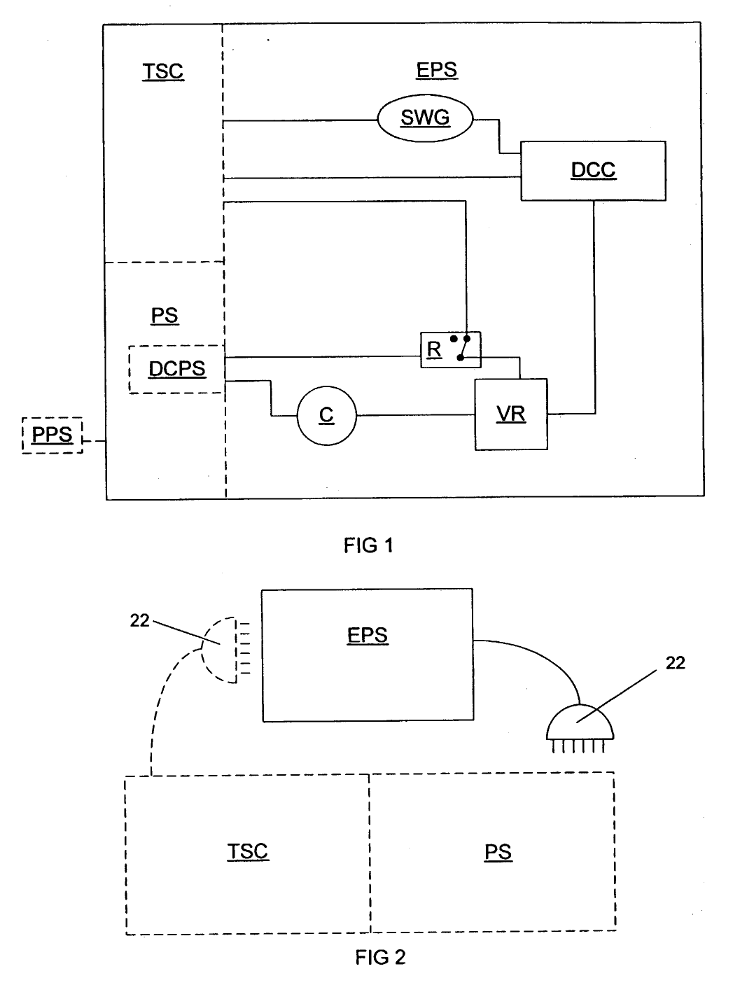

Turning now to the drawings and more particularly to FIG. 1 we have a schematic drawing of an emergency power supply EPS embedded within a power supply PS for a traffic signal controller TSC requiring a direct current power supply DCPS. The emergency power supply EPS comprises: a capacitor C to store sufficient power so that in the event of a primary power loss a power loss alarm signal is generated. The emergency power supply EPS may include a means to generate a power loss alarm signal. A voltage regulator VR is connected serially to the capacitor C output to maintain a constant output voltage in the event of a power loss. In the most preferred embodiment of the invention the capacitor comprises 10 serially connected capacitors which are Super Capacitors. As shown in FIG. 1 the traffic signal controller TSC includes a power supply PS having a direct current power supply DCPS which converts the alternating current primary power supply PPS to direct current.

In a preferred embodiment of the invention the means to generate a power loss alarm signal comprises a relay R having a primary side to which the primary power supply PPS is connected. The relay R has a secondary side which is serially connected to the output of voltage regulator VR and which is closed only when the primary power supply PPS is interrupted.

An emergency power supply EPS which is specifically designed for a traffic signal controller TSC has an output from the secondary side of the relay R (indirectly) connected to a specified input pin on the traffic signal controller TSC to immediately signal the traffic signal controller TSC in the event of a primary power supply failure so that the traffic signal controller TSC can generate and transmit an alarm signal.

FIG. 2 is a schematic drawing of an emergency power supply configured to be serially connected between a conventional direct current power supply PS for a traffic signal controller TSC and the traffic signal controller TSC. It is contemplated that in some embodiments of the invention the emergency power supply EPS may be embedded within, or be an integral part, of a power supply PS for a traffic signal controller TSC. If a traffic signal controller TSC requires a direct current input then its power supply PS must produce a direct current output. Some direct current traffic signal controllers TSC require both 5 and ±12 VDC inputs. For these, power supplies PS additionally include a direct current converter DCC producing 5 and ±12 VDC outputs to conform to the specified power requirements. These direct current traffic signal controllers TSC additionally require a 60 Hz synchronous square wave voltage input which is produced by a square wave generator SWG.

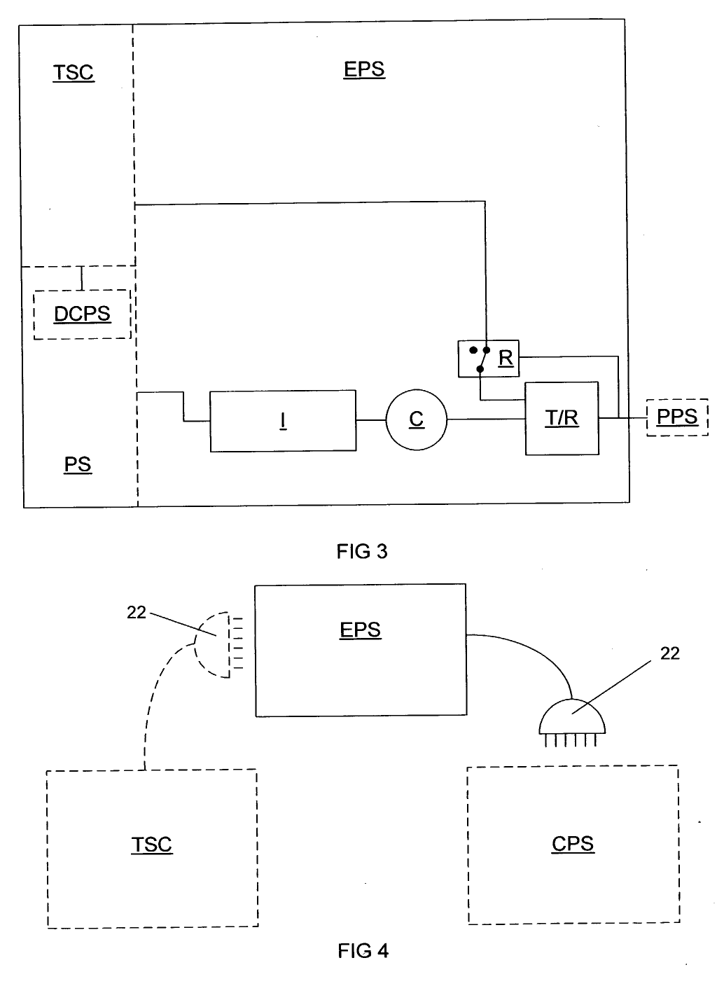

Some traffic signal controllers TSC require alternating current inputs. FIG. 3 is a schematic drawing of an emergency power supply EPS embedded within a power supply PS for a traffic signal controller TSC requiring an alternating current power supply. Power supplies PS which produce alternating current outputs are similar to a direct current power supplies DCPS as discussed above. However in these alternating current emergency power supplies EPS, alternating current AC is passed through a transformer/rectifier TR before power charges a capacitor C. Direct current output from the capacitor C passes through an inverter I, where it is converted to an alternating current wave form, for output to the traffic signal controller's power supply PS. When an inverter I is used it is not necessary that the voltage regulator VR be included. A relay R has a primary side connected to the transformer/rectifier T/R which provides the an alarm output to the traffic signal controller TSC in the event of a primary power failure.

FIG. 4 is a schematic drawing of an emergency power supply EPS configured to be serially connected between a conventional power supply CPS for a traffic signal controller and the traffic signal controller TSC. This type of an emergency power supply EPS can be used to retrofit existing systems which are not capable of generating and transmitting an emergency alarm in the event of a power failure. In this aspect of the invention the conventional power supply CPS is configured to receive as input the male output jack 22 from the emergency power supply EPS. The emergency power supply EPS is configured to receive as input the output from the traffic signal controller TSC through a similar male output jack 22 to the emergency power supply EPS so that the EPS may be plugged between an existing traffic signal controller TSC and its conventional power supply CPS.

A method of providing a power failure alarm signal from a remote traffic signal controller TSC for a central monitoring location comprises the steps of: providing an emergency power supply EPS comprising a capacitor to maintain power in the event of a primary power failure. Then in the event of the primary power supply failure, there is sufficient power to generate a power loss alarm signal. The apparatuses as specified above may additionally be provided.

While the invention has been described with preferred specific embodiments thereof, it will be understood that this description is intended to illustrate and not to limit the scope of the invention, which is defined by the following claims.

I claim:

1) An emergency power supply to provide power in the event of a primary power supply failure comprising:
a capacitor to store power;
so that in the event of the primary power supply failure, there is sufficient power to generate a power loss alarm signal.

2) An emergency power supply as in claim 1 further comprising a means to generate a power loss alarm signal.

3) An emergency power supply as in claim 2 further comprising a voltage regulator connected serially to the capacitor output to maintain a constant output voltage in the event of the primary power failure.

4) An emergency power supply as in claim 3 wherein the means to generate a power loss alarm signal comprises a relay having a primary side to which the primary power supply is connected and having a secondary side which is serially connected to the output of the voltage regulator and which is closed only in the event of the primary power supply failure.

5) An emergency power supply as in claim 4 wherein the emergency power supply is specifically for a traffic signal controller and wherein an output from the relay is connected to a specified input pin on the traffic signal controller to immediately signal the traffic signal controller in the event of a primary power supply failure so that the traffic signal controller can generate and transmit an alarm signal.

6) An emergency power supply as in claim 5 wherein the emergency power supply is embedded within a power supply for a traffic signal controller.

7) A power supply as in claim 5 wherein DC power is supplied and maintained to the traffic controller.

8) A power supply as in claim 7 further comprising a DC power converter having a 5 and ±12 VDC output, and a square wave generator, to generally conform to specified power requirements of the traffic controller.

9) A power supply for a traffic signal controller as in claim 2 wherein the means to generate a power loss alarm signal comprises a relay having a primary side to which the primary power supply is connected and having a secondary side which is serially connected to the output of the voltage regulator and which is closed only in the event of the primary power supply failure, and further comprising an inverter to supply an AC output to the traffic signal controller.

10) A power supply for a traffic signal controller as in claim 5 wherein the emergency power supply is devised to receive an output from an existing power supply and plug into the power input of an existing traffic signal controller; so that the emergency power supply is connected there between, and the traffic signal controller will generate and transmit an alarm signal in the event of a power loss.

11) A method of providing a power failure alarm signal from a remote traffic signal controller for a central monitoring location comprising the steps of:
providing an emergency power supply comprising a capacitor to maintain power in the event of a primary power failure;
so that in the event of the primary power supply failure, there is sufficient power to generate and transmita power loss alarm signal.

12) A method as in claim 11 further comprising a means to generate a power loss alarm signal.

13) A method as in claim 12 further comprising the step of providing a voltage regulator connected serially to the capacitor output to maintain a constant output voltage in the event of the primary power failure.

14) A method as in claim 13 further comprising the step of providing a relay having a primary side to which the primary power supply is connected and having a secondary side which is serially connected to the output of the voltage regulator, said relay closed only in the event of the primary power supply failure, and wherein an output from the relay is connected to a specified input pin on the traffic signal controller to immediately signal the traffic signal controller in the event of a primary power supply failure so that the traffic signal controller can generate and transmit an alarm signal.

15) A method as in claim 12 comprising the step of providing a power supply for a traffic signal controller having the emergency power supply embedded within a power supply for a traffic signal controller.

16) A method as in claim 14 comprising the step of providing an emergency power supply devised to receive an output from an existing power supply and plug into the power input of an existing traffic signal controller, so that the emergency power supply is connected there between and the traffic signal controller will generate and transmit an alarm signal in the event of a power loss.
